(19) United States
(12) Patent Application Publication
(10) Pub. No.: US 2007/0073799 A1
(43) Pub. Date: Mar. 29, 2007

(54) Adaptive user profiling on mobile devices

(75) Inventors: Iqbal Adjali, Bedford (GB); Ogi Bataveljic, Bedford (GB); Marco De Boni, Bedford (GB); Malcolm Benjamin Dias, Bedford (GB); Robert Hurling, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/239,189

(22) Filed: Sep. 29, 2005

(51) Int. Cl. G06F 15/16

(52) U.S. Cl. 709/200

(57) ABSTRACT

An apparatus for adaptive user profiling on mobile computing devices and a method of operating such devices for interacting with a user and for receiving data and instructions from a remote data resource. The method comprising detecting personal attributes of the user by interpreting one or more interactions between the device and the user, and transmitting information identifying the personal attributes of the user to the remote data resource. Determining, at the remote data resource and as a function of the transmitted information identifying personal attributes of the user, at least one of data content or program instructions to be downloaded to the mobile computing device.

The present invention relates to the content and display of information on mobile computing devices, and in particular relates to techniques of adaptively profiling users so as to optimise the displayed content.

The surge in popularity of mobile computing devices, such as laptops, PDAs, smart mobile phones and tablet PCs, together with easier accessibility to extensive networked resources such as the World Wide Web, has enabled users of such devices to gain access to all manner of data content and information in which they have an interest or desire to view. In both the modern working and recreational environments, the access to information and networked services has become vitally important to our work practices as well as to our day-to-day lifestyle preferences.

An example of where networked resources have had an impact on our every day lives is the Internet, where not only can news, weather, financial data, fashion and sport information etc. be readily retrieved and digested, but all manner of goods and services may be purchased online. However, a significant drawback of the Internet and other forms of data provision services is that content and information are provided in an ‘unintelligent’ manner, in that the content or service provider has no knowledge of the personal attributes of the user and therefore cannot know what the most appropriate content is for that user at that time.

Hence, a user may find that when they make a request for a particular content or information via the Internet for instance, a plurality of resources may be retrieved that are of no particular use or relevance to them, having regards to their interests, hobbies and likes/dislikes etc.

It is known that some limited intelligence can be introduced into e-commerce web sites and resources, by attempting to predict a user's preference for a particular subject matter or type of goods or service. Hence, when a user requests to see a particular item online, with a view to purchasing that item, the corresponding server application hosting the web site can ascertain what other online shoppers bought together with the particular item requested to be seen. In this way, a number of recommendations can be made to the user which may complement the purchase of the initial item.

However, such marketing techniques are not completely reliable and they are based purely on statistical analyses of other shoppers who are deemed to fall within the category of the present user. Hence, the techniques make no attempt to determine, nor have knowledge of, the actual personal attributes of the user.

Since the particular combinations of psychological and physiological characteristics of users differ markedly between one user and another, basic statistical techniques alone are not sufficiently accurate to ascertain the profile of an individual user. Therefore, in order to adapt a content or information to a particular user it is necessary to directly assess and determine the personal attributes of that user.

In the present invention an adaptive profiling apparatus is described that is able to determine many of the psychological and physiological characteristics of a user of a mobile computing device, in order to retrieve a content and information which are specifically suited or tailored to the likes/dislikes, interests/hobbies/activities and lifestyle preferences etc. of the user in accordance with their personal attributes.

An object of the present invention is to provide a client application that can sense and determine personal attributes of a user of a mobile computing device so as to define a profile of the user.

Another object of the present invention is to provide client and server side applications that are capable of managing a data content from a remote data resource appropriate to a user's profile.

Another object of the present invention is to provide an apparatus that can adaptively profile a user based on sensed personal attributes derived from one or more physical interactions between the user and a mobile computing device, so as to provide data content appropriate to the user's profile.

According to an aspect of the present invention there is provided a method of operating a mobile computing device for interacting with a user and for receiving data and instructions from a remote data resource, comprising:
detecting personal attributes of the user by interpreting one or more interactions between the device and the user;
transmitting information identifying the personal attributes of the user to the remote data resource;
determining, at the remote data resource and as a function of the transmitted information identifying personal attributes of the user, at least one of data content or program instructions to be downloaded to the mobile computing device.

According to another aspect of the present invention there is provided an apparatus comprising:
a mobile computing device for interacting with a user and for receiving data and instructions from a remote data resource, including:
   means for detecting personal attributes of the user by interpreting one or more interactions between the device and the user; and
   means for transmitting information identifying the personal attributes of the user to the remote data resource; and
a remote data resource including means for determining as a function of the transmitted information identifying personal attributes of the user, at least one of data content or program instructions to be downloaded to the mobile computing device.

According to another aspect of the present invention there is provided a mobile computing device for interacting with a user and for communicating with a remote data resource, comprising:
means for detecting personal attributes of the user by interpreting one or more physical interactions between the device and the user;
transmitting means for transmitting information identifying the personal attributes of the user to the remote data resource; and
receiving means for receiving at least one of data content or program instructions from the remote data resource for presentation to the user.

According to another aspect of the present invention there is provided a remote data resource for communicating with a mobile computing device, comprising:
receiving means for receiving information from the mobile computing device, the information identifying personal attributes of a user of the device;
means for determining as a function of the received information, at least one of data content or program instructions for transmitting to the device; and
transmitting means for transmitting the data content and/or program instructions to the device.

Embodiments of the present invention will now be described in detail by way of example and with reference to the accompanying drawings in which:

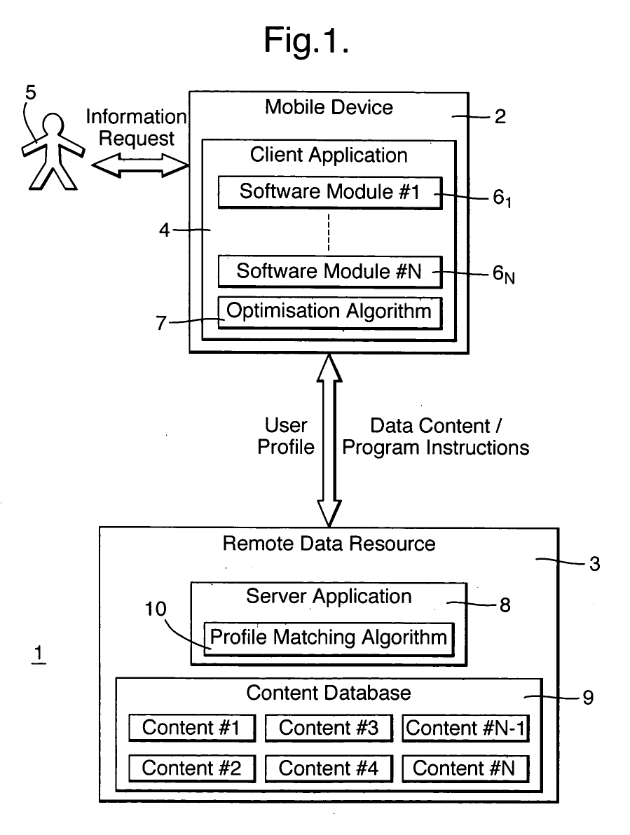

FIG. 1 is a schematic view of a preferred arrangement of an adaptive user profiling apparatus according to the present invention.

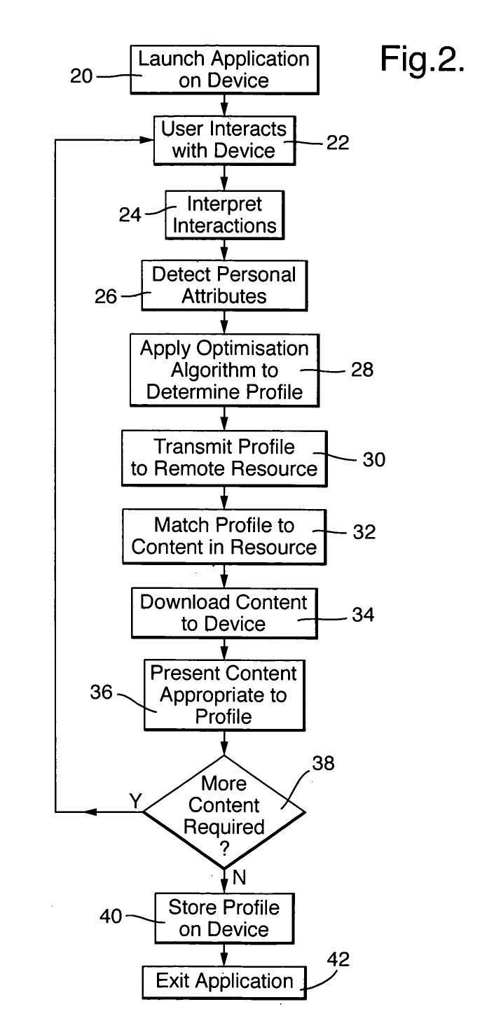

FIG. 2 is a flowchart of a preferred method of operating the apparatus of claim 1.

With reference to FIG. 1 there is shown a particularly preferred arrangement of an adaptive user profiling apparatus 1 (hereinafter referred to as the “apparatus”) according to the present invention. The apparatus 1 comprises a mobile computing device 2 and a remote data resource 3, each adapted for communication therebetween. By ‘remote’ we mean that the device 2 and the data resource 3 are physically separated and are disposed in different locations with respect to each other.

The mobile computing device 2 (hereinafter referred to as the ‘mobile device’) is of a kind that is capable of executing the client application 4 of the present invention, and is preferably one of the following devices: a laptop computer, a personal digital assistant (PDA), a smart mobile phone or a tablet PC, modified in accordance with the prescriptions of the following arrangements. It is to be appreciated however, that the mobile device 2 may be any suitable portable data exchange device that is capable of interacting with a user (e.g. by receiving instructions and providing information by return).

Preferably, the client application 4 may be implemented using any suitable programming language, e.g. JavaScript and is preferably platform/operating system independent, to thereby provide portability of the application to different mobile devices. In these arrangements, it is intended that the client application 4 be installed on the mobile device 2 by accessing a suitable software repository, either remotely via the internet, or directly by inserting a suitable media containing the repository (e.g. CD-rom, DVD, Compact Flash, Secure Digital card etc.) into the device 2.

In alternative arrangements, the client application 4 may be pre-installed in the mobile device 2 during manufacture, and would preferably reside on a ROM (read only memory) chip or other suitable non-volatile storage device or integrated circuit.

In accordance with the present invention, the client application 4 is operable to detect the personal attributes of a user 5 of the mobile device 2 by interpreting one or more interactions between the device 2 and the user 5. In this way, it is possible to determine a profile of the user 5 that defines at least some of the psychological and/or physiological characteristics of the user 5. Knowledge of this profile may then allow data content to be identified that is particularly relevant and/or suited to the user 5, and for this content to be presented in the most appropriate manner for the user 5.

The ‘personal attributes’ of a user typically relate to a plurality of both psychological and physiological characteristics that form a specific combination of features and qualities that define the ‘make-up’ of a person. Most personal attributes are not static characteristics, and hence they generally change or evolve over time as a person ages for instance. In the context of the present invention, the personal attributes of a user include, but are not limited to, gender, age, ethnic group, hair colour, eye colour, facial marks, complexion, health, medical conditions, personality type (e.g. dominant, submissive etc.), likes/dislikes, interests/hobbies/activities and lifestyle preferences.

However, it is to be appreciated that other attributes may be also be used to define the characteristics of, or relating to, a person (e.g. education level, salary, homeowner, marital and employment status etc.), and therefore any suitable attribute for the purpose of adaptively profiling a user is intended to be within the meaning of ‘personal attribute’ in accordance with the present invention.

By ‘interaction’ we mean any form of mutual or reciprocal action that involves an exchange of information or data in some form, with or without physical contact, between the mobile device 2 and the user 5. For example, interactions include, but are not limited to, touching the device (e.g. holding, pressing, squeezing etc.), entering information into the device (e.g. by typing), issuing verbal commands/instructions to the device (e.g. via continuous speech or discrete keywords), image capture by the device and presentation of audio and/or visual content by the device (i.e. listening to and/or watching content on the device). Furthermore, an interaction may be related to a mode or manner of use of the device 2, involving one or more of the foregoing examples, e.g. playing music on the device or accessing regular news updates etc.

In preferred arrangements, the client application 4 includes one or more software modules 6₁. . . 6_{N}, each module specifically adapted to process and interpret a different type of interaction between the device 2 and the user 5. Alternatively, the client application 4 may include only a single software module that is adapted to process and interpret a plurality of different types of interaction.

The ability to process and interpret a particular type of interaction however, depends on the kinds of interaction the mobile device 2 is able to support. Hence, for instance, if a ‘touching’ interaction is to be interpreted by a corresponding software module 6₁. . . 6_{N}, then the mobile device 2 will need to have some form of haptic interface (e.g. a touch sensitive keyboard, casing, mouse or screen etc.) fitted or installed.

Therefore, in accordance with the present invention, the mobile device 2 preferably includes one or more of any of the following components, sensors or sensor types, either as an integral part of the device (e.g. built into the exterior housing/casing etc.) or as an ‘add-on’ or peripheral component (e.g. mouse, microphone, webcam etc.) attached to the device.

A Pressure Sensor/Transducer

This type of sensor may form part of, or be associated with, the exterior housing or case of the mobile device 2. It may also, or instead, form part of, or be associated with, a data input area (e.g. screen, keyboard etc.) of the device, or form part of a peripheral device, e.g. built into the outer casing of a mouse etc.

For instance, the pressure sensor would be operable to sense how hard/soft the device 2 is being held (e.g. tightness of grip) or how hard/soft the screen is being depressed (e.g. in the case of a PDA or tablet PC) or how hard/soft the keys of the keyboard are being pressed etc.

A corresponding software module, i.e. the ‘Pressure Processing and Interpretation Module’ (PPIM), in the client application 4 receives the pressure information from the interactions between the mobile device 2 and user 5, by way of a pressure interface circuit coupled to the one or more pressure sensors, and interprets the tightness of grip, the hardness/softness of the key/screen depressions and the pattern of holding the device etc. to establish personal attributes of the user 5.

For instance, if the screen and/or keys are being depressed in a hard (i.e. overly forceful) manner, the PPIM may determine that the user 5 is exhibiting aggressive tendencies or is possibly angry or stressed. Likewise, if the device 2 is being held in a overly tight grip, this may also be indicative of the user 5 feeling stressed or anxious etc.

The tightness of grip and/or screen or key depression may also provide an indication of gender, as generally male users are more likely to exert a greater force in gripping and operating the device 2 than female users, although careful discrimination would be required to distinguish between a stressed female user. Hence other personal attributes would need to be taken into consideration during the interpretation.

The ‘pressure interface circuit’ may be any suitable electronic circuit that is able to receive electrical signals from the one or more pressure sensors and provide a corresponding output related to the magnitude and location of the applied pressure, the output being in a form suitable for interrogation by the PPIM.

The PPIM may also interpret pressure information concerning the points of contact of the user's fingers with the device 2 (i.e. the pattern of holding), which could be useful in assessing whether the user is left handed or right handed etc.

Health diagnostics may also be performed by the PPIM to assess the general health or well-being of the user 5, by detecting the user's pulse (through their fingers and/or thumbs) when the device 2 is being held. In this way, the user's blood pressure may be monitored to assess whether the user 5 is stressed and/or has any possible medical problems or general illness.

It is to be appreciated that any suitable conventional pressure sensor or pressure transducer may be used in the mobile device 2, provided that it is able to produce a discernable signal that is capable of being processed and interpreted by the PPIM. Moreover, any number of pressure sensors may be used to cover a particular portion and/or surface of the device or peripheral component etc. as required.

A Temperature Sensor

This type of sensor may form part of, or be associated with, the exterior housing or case of the mobile device 2, in much the same manner as the pressure sensor above. It may also, or instead, form part of, or be associated with, a data input area (e.g. screen, keyboard etc.) of the device 2, or form part of a peripheral device, e.g. built into the outer casing of a mouse etc.

One or more temperature sensors gather temperature information from the points of contact between the mobile device 2 and the user 5 (e.g. from a user's hand when holding the device 2, or from a user's hand resting on the device etc.), so as to provide the corresponding software module, i.e. the ‘Temperature Processing and Interpretation Module’ (TPIM), with information concerning the user's body temperature.

Preferably, the one or more temperature sensors are coupled to a temperature interface circuit, that is any suitable electronic circuit that is able to receive electrical signals from the sensors and provide a corresponding output related to the magnitude and location of the temperature rise, the output being in a form suitable for interrogation by the TPIM.

A user's palm is an ideal location from which to glean body temperature information, as this area is particularly responsive to stress and anxiety, or when the user is excited etc. Hence, a temperature sensor may be located in the outer casing of a mouse for instance, as generally the user's palm rests directly on the casing.

The temperature sensor may also be in the form of a thermal imaging camera, which captures an image of the user's face for instance, in order to gather body temperature information. The user's body temperature may then be assessed using conventional techniques by comparison to a standard thermal calibration model.

The TPIM interprets the temperature information to determine the personal attributes of the user 5, since an unusually high body temperature can denote stress or anxiety, or be indicative of periods of excitement. Moreover, the body temperature may also convey health or well-being information, such that a very high body temperature may possibly suggest that the user 5 is suffering from a fever or flu etc. at that time.

It is to be appreciated that any suitable conventional temperature sensor may be used in the mobile device 2, provided that it is able to produce a discernable signal that is capable of being processed and interpreted by the TPIM. Moreover, any number of temperature sensors may be used to cover a particular portion or surface of the device and/or peripheral component etc. as required.

A Chemical Sensor

This type of sensor may form part of, or be associated with, the exterior housing or case of the mobile device 2 in much the same manner as the pressure and temperature sensors above. It may also, or instead, form part of, or be associated with, a data input area (e.g. screen, keyboard etc.) of the device 2, or form part of a peripheral device, e.g. built into the outer casing of a mouse etc.

The one or more chemical sensors gather information from the points of contact between the mobile device 2 and the user 5, and are operable to sense the quantity and composition of the user's perspiration by preferably analysing the composition of body salts in the perspiration. By ‘body salts’ we mean any naturally occurring compounds found in human perspiration.

Preferably, the one or more chemical sensors are coupled to a chemical interface circuit, that is any suitable electronic circuit that is able to receive electrical signals from the sensors and provide a corresponding output related to the quantity and composition of the user's perspiration, the output being in a form suitable for interrogation by a corresponding software module (discussed below).

A user's fingertips and palm are ideal locations from which to glean perspiratory information, as these areas are particularly responsive to stress and anxiety, or when the user 5 is excited etc. Hence, a chemical sensor may be located in the outer casing of a mouse for instance, as generally the user's palm rests directly on the casing and the buttons are operated by their fingertips.

The chemical information is interpreted by the ‘Chemical Processing and Interpretation Module’ (CPIM) in the client application 4, which assesses whether the user 5 is exhibiting unusually high levels of perspiration, which may therefore be indicative of periods of stress or anxiety, or of excitement etc., as well as denoting possible environmental conditions effecting the user 5, e.g. as on a hot sunny day etc. The composition of the perspiration may also be indicative of the general health and well-being of the user 5, as the body salt composition of perspiration can change during illness.

Moreover, a long term assessment of the quantity of perspiration may also provide evidence of whether a user 5 is predisposed to exhibiting high levels of perspiration, e.g. due to being over-weight or as arising from glandular problems etc. and may therefore suggest that the user 5 might possibly have issues with body odour and/or personal hygiene.

The chemical sensor may instead, or additionally, be in the form of an odour sensor and therefore does not need the user 5 to physically touch the mobile device 2 in order to assess whether the user 5 is overly perspiring and/or has some other form of natural odour problem e.g. halitosis.

It is to be appreciated that any suitable chemical sensor may be used in the mobile device 2, provided that it is able to produce a discernable signal that is capable of being processed and interpreted by the CPIM. Moreover, any number of chemical sensors may be used to cover a particular portion or surface of the device or peripheral component etc. as required.

An Audio Sensor

This type of sensor will typically be in the form of a microphone that is built into the exterior housing or case of the mobile device 2, or else is connected to the device 2 by a hardwire or wireless connection etc.

The audio sensor is operable to receive voice commands and/or verbal instructions from the user 5 which are issued to the mobile device 2 in order to perform some function, e.g. requesting data content or information etc. The audio sensor may respond to both continuous (i.e. ‘natural’) speech and/or discrete keyword instructions.

The audio information is provided to a corresponding software module, i.e. the ‘Audio Processing and Interpretation Module’ (APIM), which interprets the structure of the audio information and/or verbal content of the information to determine personal attributes of the user 5. The APIM preferably includes a number of conventional parsing algorithms, so as to parse natural language requests for subsequent analysis and interpretation.

The APIM is also configured to assess the intonation of the user's speech using standard voice processing and recognition algorithms to assess the personality type of the user 5. A reasonably loud, assertive, speech pattern will typically be taken to be indicative of a confident and dominant character type, whereas an imperceptibly low (e.g. whispery), speech pattern will usually be indicative of a shy, timid and submissive character type.

The intonation of a user's speech may also be used to assess whether the user is experiencing stress or anxiety, as the human voice is generally a very good indicator of the emotional state of a user 5, and may also provide evidence of excitement, distress or nervousness. The human voice may also provide evidence of any health problems (e.g. a blocked nose or sinuses) or longer term physical conditions (e.g. a stammer or lisp etc.)

The APIM may also make an assessment of a user's gender, based on the structure and intonation of the speech, as generally a male voice will be deeper and lower pitched than a female voice, which is usually softer and higher pitched. Accents may also be determined by reference to how particular words, and therein vowels, are framed within the speech pattern. This can be useful in identifying what region of the country a user 5 may originate from or reside in. Moreover, this analysis may also provide information as to the ethnic group of the user 5.

The verbal content of the audio information can also be used to determine personal attributes of the user 5, since a formal, grammatically correct sentence will generally be indicative of a more educated user, whereas a colloquial, or poorly constructed, sentence may suggest a user who is less educated, which in some cases could also be indicative of age (e.g. a teenager or child).

Preferably, the grammatical structure of the verbal content is analysed by a suitable grammatical parsing algorithm within the APIM.

Furthermore, the presence of one or more expletives in the verbal content, may also suggest a less educated user, or could possibly indicate that the user is stressed or anxious. Due to the proliferation of expletives in every day language, it is necessary for the APIM to also analyse the intonation of the sentence or instruction in which the expletive arises, as expletives may also be used to convey excitement on the part of the user or as an expression of disbelief etc.

Preferably, the APIM is configured to understand different languages (other than English) and therefore the above interpretation and assessment may be made for any of the languages for which the client application 4 is intended for use. Therefore, the nationality of the user 5 may be determined by an assessment of the language used to interact with the mobile device 2.

It is to be appreciated that any suitable audio sensor may be used in, or with, the mobile device 2, provided that it is able to produce a discernable signal that is capable of being processed and interpreted by the APIM.

A Visual Sensor

This type of sensor will typically be in the form of a video camera, preferably based on conventional CCD (Charge Coupled Device) or CMOS (Complementary Metal Oxide Semiconductor) devices. The visual sensor may be built into the exterior housing or case of the mobile device 2 (e.g. as in mobile phone cameras), or else may be connected to the device 2 by a hardwire or wireless connection etc. (e.g. such as a webcam).

The visual sensor is operable to obtain a 2-dimensional image of the user's face, either as a continuous stream of images (i.e. in real-time) or as discrete ‘snap-shot’ images, taken at periodic intervals, e.g. every 0.5 seconds. The images are provided to a corresponding software module, i.e. the ‘Visual Processing and Interpretation Module’ (VPIM), which contains conventional image processing algorithms. The VPIM is configured to interpret the images of the user's face so as to determine personal attributes of the user 5.

The VPIM is able to make an assessment as to the gender of the user 5 based on the structure and features of the user's face. For instance, male users will typically have more distinct jaw-lines and more developed brow features than the majority of female users. Also, the presence of facial hair is usually a very good indicator of gender, and therefore, should the VPIM identify facial hair (e.g. a beard or moustache) this will be interpreted as being a characteristic of a male user.

However, this interpretation may require reference to other personal attributes, as a female user may have a hair style that is swept across a portion of her face, thereby possibly causing confusion during VPIM analysis.

The VPIM is able to determine the tone or colour of the user's face and therefore can determine the likely ethnic group to which the user belongs. The tone or colour analysis is performed over selected areas of the face (i.e. a number of test locations are dynamically identified, preferably on the cheeks and forehead) and the ambient lighting conditions and environment are also taken into account, as a determination in poor lighting conditions could otherwise be unreliable.

The hair colour of the user 5 may also be determined using a colour analysis, operating in a similar manner to the skin tone analysis, e.g. by selecting areas of the hair framing the user's face. In this way, blonde, brunette and redhead hair types can be determined, as well as grey or white hair types, which may also be indicative of age. Moreover, should no hair be detected, this may also suggest that the user is balding, and consequently is likely to be a middle-aged, or older, male user. However, reference to other personal attributes may need to be made to avoid any confusion, as other users, either male or female, may have selected to adopt a shaven hair style.

Also, where a user 5 interacts with the mobile device 2 while wearing a hat or hood etc. then no determination as to hair colour will be made by the VPIM.

The eye colour of the user 5 may also be determined by the VPIM by locating the user's eyes and then retinas in the images. An assessment of the surrounding part of the eye colour may also be made, as a reddening of the eye may be indicative of eye complaints (e.g. conjunctivitis, over-wearing of contact lenses or a chlorine-allergy arising from swimming etc.), long term lack of sleep (e.g. insomnia), or excessive alcoholic consumption. Furthermore, related to the latter activity, the surrounding part of the eye, may exhibit a ‘yellowing’ in colour which may be indicative of liver problems (e.g. liver sclerosis). Again, however, any colour assessment is preferably made with knowledge of the ambient lighting conditions and environment, so as to avoid unreliable assessments.

If in any of the colour determination analyses, i.e. skin tone, hair type and eye colour, the VPIM decides that the ambient conditions and/or environment may give rise to an unreliable determination of personal attributes, then it will not make any assessment until it believes that the conditions preventing a reliable determination are no longer present.

In assessing skin tone, the VPIM is also able to make a determination as to the user's complexion, so as to identify whether the user suffers from any skin complaints (e.g. acne) or else may have some long term blemish (e.g. a mole or beauty mark), facial mark (e.g. a birth mark) or scarring (e.g. from an earlier wound or burning).

In certain cases, it also possible for the VPIM to determine whether the user wears any form of optical aid, since a conventional edge detection algorithm is preferably configured to find features in the user's image corresponding to spectacle frames. In detecting a spectacle frame, the VPIM will attempt to assess whether any change in colouration is observed outside of the frame as compared to inside the frame, so as to decide whether the lens material is clear (e.g. as in normal spectacles) or coloured (i.e. as in sunglasses). In this way, it is hoped that the VPIM can better distinguish between user's who genuinely have poor eyesight and those who wear sunglasses for ultra-violet (UV) protection and/or for fashion.

It is to be appreciated however, that this determination may still not provide a conclusive answer as to whether the user has poor eyesight, as some forms of sunglasses contain lenses made to the user's prescription or else are of a form that react to ambient light levels (e.g. Polaroid lenses).

In preferred arrangements, the VPIM is also configured to interpret the facial expressions of the user 5 by analysis of the images of the user's face over the period of interaction. In this way, the mood of the user may be assessed which can be indicative of the user's personality type and/or emotional state at that time. Hence, a smiling user, will generally correspond to a happy, personable, personality type, whereas a frowning user, may possibly be an unhappy, potentially depressive, personality type.

However, it is to appreciated that a single interaction may not convey the true personality type of the user, as for instance, the user may be particularly unhappy (hence, more inclined to frown) at the time of that interaction, but is generally very personable on a day-to-day basis. Hence, it may be necessary to assess facial expressions generally over a plurality of interactions, each at different times.

An analysis of the facial expressions of the user 5 can provide evidence of the emotional state of the user, and/or can be indicative of whether the user is under stress or is anxious. Moreover, it may be determined whether the user is angry, sad, tearful, tense, bewildered, excited or nervous etc., all of which can be useful in determining personal attributes of the user, so as to adaptively profile the user.

In preferred arrangements, the VPIM interprets facial features and expressions by reference to a default calibration image of the user's face, which is preferably obtained during an initialisation phase of the client application 4 (e.g. after initial installation of the application). The default image corresponds to an image of the user's face when no facial expression is evident, i.e. when the user's face is relaxed and is neither smiling, frowning or exhibiting any marked facial contortion. Therefore, when subsequent images of the user's face are obtained, the motion and displacement of the recognised facial features can be compared to corresponding features in the default image, thereby enabling an assessment of the facial expression to be made.

In some arrangements, the visual sensor may also function as a thermal imager (as discussed in above in relation to the temperature sensor), and therefore may also provide body temperature information about the user 5, which may be used in the manner described above to determine personal attributes of the user 5.

Mode of Use

In addition to interpreting interactions between the mobile device 2 and the user 5 using any of the one or more preceding sensor or sensor types, the client application 4 also preferably has a dedicated software module which monitors and interprets the user's ‘mode of use’ of the device. Clearly, the mode of use of the device can involve any of the above types of interaction, therefore for example, a user may hold the device to issue verbal commands so as to request a particular video content to be displayed to him.

A mode of use of the device can provide important information concerning the personal attributes of the user, as the use may indicate a particular function, or functions, for which the device is frequently used (e.g. playing music, surfing the internet, managing appointments and calendars etc.) and/or otherwise suggest a particular content, subject matter, and/or activity in which the user is seemingly interested (e.g. regular news updates, fashion information, sport, gardening etc.).

Moreover, the particular type or types of interaction that occur while using the device 2 may also be indicative of a user's personal attributes, as for instance, a user who only uses a device to download and play music, is seemingly not interested in using the device for word processing or other functions etc, and a user who only ever enters textual requests into the device, is seemingly unwilling and/or uncomfortable with issuing verbal instructions to the device.

It is to be appreciated therefore that the mode of use of the mobile device 2 may include a plurality of different activities, encompassing different interests and pursuits. Moreover, it is likely that the mode of use may change during the day or at weekends etc., since the user 5 will usually use the device 2 differently when at work and during leisure. Hence, for example, in the case of a WAP enabled mobile phone, the user may use the phone to make numerous business calls during the working day, but during evenings and weekends may download restaurant and wine bar listings, or cinema showings and times etc.

An interpretation of the use of the mobile device 2 can identify many of the personal attributes of the user and therefore an analysis of the mode of use of the device can lead to an assessment of the likes and dislikes, interests, hobbies, activities and lifestyle preferences of the user 5. Moreover, the use may also provide an indication as to the gender and/or age of the user 5, as for example music (i.e. ‘pop’) videos of male bands are likely to be accessed by female teenagers, whereas hair-loss treatment content is most likely to be requested by middle-aged males.

It may also be possible to determine the health status, or general well-being, of the user, if the user frequently requests content relating to specific ailments and/or treatments for a certain condition. In a like manner, an assessment as to whether a user is over-weight may be made, if the user accesses content related to weight loss or slimming programmes or diets etc.

In preferred arrangements, the ‘Mode of Use Processing and Interpretation Module’ (MUPIM) in the client application 4, is therefore adapted to monitor the use of the device to determine the particular functions for which the device is used and the nature of the content which is requested by the user. Hence, the MUPIM preferably includes a task manager sub-module, which monitors the particular applications and tasks that are executed on the processor of the mobile device 2. In preferred arrangements, the task manager maintains a non-volatile log file of the applications and tasks that have been used by the user during a recent predetermined interval, e.g. within the last 30 days, and scores the frequency of use of the applications. For example, if a web browser has been launched on the device twice a day for the last 30 days, the web browser's score would be 60, whereas if a spreadsheet application has been launched only once, its score would be 1. Hence, in this way the MUPIM can determine the user's preferred use of applications and can use this information to ascertain personal attributes of the user.

It is to be appreciated that any suitable technique of ‘scoring’ may be used, and if needed, any appropriate statistical algorithm can be applied to the scores in order to ascertain any particular property related to the distribution of scores, e.g. mean, standard deviation, maximum likelihood etc., should this be useful in identifying preferred modes of use.

Preferably, the MUPIM is also configured to monitor file usage and URL (Universal Resource Locator) data, by analysing the file extensions of the former and recording the addresses of the latter in a non-volatile log file (which may or may not be the same as the log file used by the task manager). An analysis of the file extensions may provide information about the types of file that are routinely accessed by the user (either locally or via the internet), as a user who predominantly plays music will frequently execute .mp3, .wma, .wav, ram. type files, while a user who uses their device for work related purposes may frequently access word processing files, e.g. .doc, .wp, .lot and spreadsheet files, e.g. .xls, .lxs etc. In a similar manner to the application usage, the file usage may also be ‘scored’ over a predetermined period, and therefore can provide useful information as to the personal attributes of the user.

The recorded URL data is analysed with reference to predetermined web content categories within the MUPIM. These categories each contain web addresses and resources which exemplify that particular category of content. For instance, in the ‘news’ category, the MUPIM stores the web addresses: www.bbc.co.uk, www.itn.co.uk, www.cnn.com, www.reuters.com, www.bloomberg.com etc. and therefore compares the recorded URLs against the exemplary addresses of each category (e.g. weather, fashion, sport, hobbies, e-commerce etc.) until a match to the whole or part of the domain is found. If no match is found, the URL is flagged in the log file, and can then be ignored during subsequent adaptive profiling. To avoid any appreciable impact on the performance of the mobile device 2, the MUPIM is preferably configured so as to perform URL matching when the device is idle (e.g. when no interactions have been detected within an appropriate interval of time and no applications are running on the device 2—other than the client application 4). The results of this analysis may then be subsequently used during the next adaptive profiling of the user.

Preferably, in addition to URL matching, the MUPIM may also inspect HTML and XML headers of viewed web pages, so as to ascertain the category of content of that web page. For example, in inspecting the BBC's news home page, the word “news” may be found in the header, and therefore the MUPIM may decide that the user is accessing news content, which could later be verified by URL matching for instance.

In preferred arrangements, the MUPIM also includes an input text parser which monitors textual commands (e.g. URLs) that are input into certain applications (e.g. web browsers) by the user during a particular interaction. The text parser may be used in complementary manner with the grammatical parsing algorithm of the APIM, or else may include its own grammatical parser. The MUPIM analyses input text commands and performs keyword searches, so as to identify particular categories of content. For example, if a user launches a web browser on the mobile device and enters the address “www.patent.gov.uk”, the MUPIM would identify the word “patent” by reference to an internal dictionary and would ascertain that the user requires content on intellectual property. The internal dictionary may be any suitable electronic dictionary or compiled language resource.

It is to be appreciated that the MUPIM may be configured to also monitor other task management characteristics and perform any suitable function that enables the mode of use of the device to be determined in order to adaptively profile a user. In particular, the MUPIM may also ‘time tag’ entries in any of the associated log files, so that the time spent downloading, accessing, and using certain types of files, applications or other resources can be determined. All of this may be used to determine personal attributes of the user.

In any of the preferred arrangements in which the MUPIM performs an operation or function, it is to be appreciated that the MUPIM may be configured to execute that particular operation and function in real-time (i.e. during the interaction) or when the mobile device 2 is idle or not in use, so as to not have an impact on the overall performance of the device. Moreover, in any arrangement involving a log file, the MUPIM may be configured to maintain the log file in a circular update manner, so that any entries older than a certain date are automatically deleted, thereby performing house-keeping operations and ensuring that the log file does not increase in size indefinitely.

In preferred arrangements, at any point during the interaction(s) between the mobile device 2 and user 5, the client application 4 can decide that on the basis of the information provided by one or more of the software modules (PPIM, TPIM, CPIM, APIM, VPIM and MUPIM) that one or more optimisation algorithms 7. is to be executed on the mobile device 2.

The optimisation algorithm 7 receives information from the respective software modules 6₁. . . 6_{N} that are, or were, involved in the most recent interaction(s) and uses that information to adaptively profile the user 5 of the mobile device 2. The information from the software modules 6₁. . . 6_{N} is based on the interpretations of those modules and corresponds to one or more of the personal attributes of the user. In preferred arrangements, the information is provided to the optimisation algorithm 7 by way of keyword tags, which may be contained in a standard text file produced by each of the software modules 6₁. . . 6_{N}. Upon execution of the optimisation algorithm 7, the algorithm preferably accesses the available text files and performs an analysis and optimisation of the keyword tag data.

It is to be appreciated that the information may be passed to the optimisation algorithm 7 by way of any suitable file type, including HTML or XML etc, or alternatively may be kept in a memory of the mobile device 2 for subsequent access by the optimisation algorithm 7.

By way of example, in a case where the PPIM has decided that the device 2 was being held very firmly, by a left handed person, and that the keys have been pressed excessively hard, it therefore provides the following keyword tags in a text file to the optimisation algorithm 7:

[GENDER] [M] [?]
[GRIP] [FIRM] [ ]
[KEYPRESS] [HARD] [ ]
[HAND] [L] [ ]
[STRESS] [Y] [?]

In preferred arrangements, the first encountered square brackets [ ] of each line of data contain a predetermined personal attribute tag, e.g. [GENDER], which are common to the software modules 6₁ . . . 6_{N} and optimisation algorithm 7. The second encountered square brackets [ ] of each line contains the personal attribute as determined by the respective software module and the third encountered square brackets [ ] denotes whether this determination is deemed to be inconclusive or indeterminate on the basis of the information available to the software module. If so, the module will enter a ? in the third square brackets, which is then left to the optimisation algorithm 7 to resolve, having regard to any corresponding determinations made by the other software modules 6₁ . . . 6_{N}. If no information is available concerning a particular attribute then this information is not passed to the optimisation algorithm 7.

Hence, in the preceding example the PPIM has determined those personal attributes which it is capable of doing so from that interaction and has made a judgement that due to the firmness of the grip etc., the user 5 may possibly be male and may possibly be stressed.

During the same example interaction, the VPIM has captured a sequence of images of the user and has interpreted the facial features and expressions of the user to provide the following keyword tags to the optimisation algorithm 7:

[GENDER] [M] [ ]
[FACIAL HAIR] [Y] [ ]
[HEAD HAIR] [N] [ ]
[SKIN TONE] [WHITE] [ ]
[EYE COLOUR] [BROWN] [ ]
[OUTER EYE COLOUR] [WHITE] [ ]
[FACIAL MARKS1] [SCAR] [?]
[FACIAL MARKS2] [MOLE] [ ]
[EXPRESSION1] [FROWN] [ ]
[EXPRESSION2] [ANGRY] [?]
[EXPRESSION3] [STRESS] [ ]

Hence, the VPIM has determined the user's personal attributes to be male, on the basis of the user's facial structure, that he has facial hair (further supporting the findings of the facial structure analysis), that he has no appreciable head hair e.g. is bald (again supporting the gender determination), that he is Caucasian, with brown, healthy eyes, with a mole and a possible scar and is frowning, stressed and possibly angry.

It is noted that, in this example, as the VPIM has determined that the user has no head hair, no [HAIR COLOUR] tag has been passed to the optimisation algorithm 7. Therefore, the optimisation algorithm 7 will only profile a user on the basis of the information determined by the software modules 6₁ . . . 6_{N}, and therefore in the absence of a particular keyword tag will not make any assertion as to that personal attribute. However, the optimisation algorithm 7 is able to make deductions based on corresponding keyword tags, and therefore in the preceding example, since the [HEAD HAIR] tag is false, the optimisation algorithm 7 may be inclined to base the user's profile on a bald or balding individual.

During execution, the optimisation algorithm 7 will compile all of the available keyword tags that have been provided to it by the software modules 6₁ . . . 6_{N} (via the respective text files or directly from memory). Any conflicts between determined personal attributes and/or any indeterminate flags [?] will be resolved first, therefore, if the user's voice has indicated that the user is happy but the user's facial expression suggests otherwise, the optimisation algorithm 7 will then consult other determined personal attributes, so as to decide which attribute is correct. Hence, in this example, the optimisation algorithm 7 may inspect any body temperature information, pressure information (e.g. tightness of grip/hardness of key presses etc.), quantity and composition of the user's perspiration etc. in order to ascertain whether there is an underlying stress or other emotional problem that may have been masked by the user's voice.

In preferred arrangements, if any particular conflict between personal attributes cannot be resolved, the optimisation algorithm 7 will then apply a weighting algorithm which applies predetermined weights to keyword tags from particular software modules 6₁ . . . 6_{N}. Hence, in this example, the facial expression information is weighted higher than voice information (i.e. greater weight is given to the personal attributes determined by the VPIM than those determined by the APIM), and therefore, the optimisation algorithm 7 would base the profile on a frowning or unhappy individual.

It is to be appreciated that any suitable weighting may be applied to the personal attributes from the software modules 6₁ . . . 6_{N}, depending on the particular profiling technique that is desired to be implemented by the optimisation algorithm 7. However, in preferred arrangements the weights are assigned as follows (in highest to lowest order): MUPIM→VPIM→APIM→PPIM→TPIM→CPIM.

Hence, any dispute between personal attributes determined by the MUPIM and the APIM, will be resolved (if in no other way) by applying a higher weight to the attributes of the MUPIM than those of the APIM.

Following the resolution of any disputes, the optimisation algorithm 7 will then use the determined personal attributes of the user to define a profile of that user, that will embody many of the psychological and physiological characteristics of that individual. Therefore, the optimisation algorithm 7 will attempt to match the personal attributes of the user to a plurality of hierarchical profile categories preferably associated with the algorithm 7. In preferred arrangements, each ‘profile category’ is separately defined by a predetermined set of one or more personal attribute criteria, which if found to correspond to the personal attributes of the user will indicate the category of profile to which the user belongs. For instance, the first two categories are male or female; then age group (e.g. <10 yrs, 10-15 yrs, 16-20 yrs, 21-30 yrs, 31-40 yrs, 41-50 yrs, 51-60 yrs, >60 yrs); ethnic group (e.g. Caucasian, black, asian etc.), hair colour (e.g. blond, brunette, redhead etc.) and so on, further sub-dividing through physical characteristics and then preferences—likes/dislikes, hobbies/interests/activities and lifestyle preferences etc.

When matching is complete, the optimisation algorithm 7 will then have identified the most appropriate profile to the user 5 of the mobile device 2, based on the personal attributes determined by the software modules 6₁ . . . 6_{N} from the one or more interactions between the device 2 and the user 5.

In preferred arrangements, the optimisation algorithm 7 is configured to record this profile in a standard text file or other suitable file format, e.g. XML document, for transmitting to the remote data resource 3. It is to be appreciated that any suitable file format may be used to transfer the user profile to the data resource 3, provided that the format is platform independent so as to aid the portability of the present apparatus to different system architectures.

A particular feature of the present invention, is that the apparatus 1 is configured to employ a technique of ‘continuance’, that is the apparatus 1 remembers (i.e. retains and stores) the profile of the user between interactions. Therefore, the optimisation algorithm 7 is adapted to search the storage devices of the mobile device 2, e.g. non-volatile memory or hard disk drive etc. for an existing profile of the user. Hence, when the optimisation algorithm 7 is executed, should any existing profile be found, the algorithm will attempt to update it as opposed to defining a completely new profile. The updating of a profile can be significantly less demanding on the resources of the mobile device 2, as many of the personal attributes will already be known prior to the subsequent execution of the optimisation algorithm 7. Therefore, the optimisation algorithm 7 performs a ‘verification check’, to ascertain those attributes that have not changed since the last interaction, e.g. gender, skin tone and age (depending on the timescales between interactions) etc. Hence, in this way the optimisation algorithm 7 need only match the recently changed personal attributes in order to update the user's profile.

In preferred arrangements, the mobile device 2 and remote data resource 3 communicate using any suitable wireless communications protocol over a telecommunications network, either directly or by way of one or more networked routers. In particular, in the case of mobile phone devices, the communications can take place via the telecommunications cellular phone network.

When a user 5 of the mobile device 2 issues a request for information or content that is not available locally on the mobile device 2, that device establishes a session with the data resource 3 via the communications protocol (e.g. performs conventional handshaking routines). The interaction between the mobile device 2 and the user 5 causes the profile of the user to be adaptively defined (or updated) by the client application 4 (by executing the software modules 6₁ . . . 6_{N} and optimisation algorithm 7 as described). The user's request is then sent to the data resource 3, along with the user's profile, which are received by a server application 8 that is adapted for execution on the data resource 3.

The data resource 3 may be any suitable server architecture that is capable of receiving and transmitting information via wireless communications, or via wired links to a wireless router etc., and includes at least one ‘content’ database 9, either as an integral component of the server or else attached thereto. Preferably, the data resource 3 also operates as a gateway to the internet, allowing the user of the mobile device 2 to request information or content that is not local to the data resource 3 but may instead be readily accessed by connecting to the extensive resources of the internet.

The server application 8 is preferably implemented using any suitable programming language, e.g. C, C++, JavaServer script etc., and includes at least one profile matching algorithm 10. Upon receipt of the user's request and profile, the server application 8 identifies the nature of the request, for example, whether a particular local file or type of file is desired, whether an internet resource is required, and/or whether an applet or other programmed instructions are to be returned to the user etc. However, no particular content will be identified until the server application 8 executes the profile matching algorithm 10, which then matches the profile of the user to a content and/or programmed instructions specific to the profile category of the user.

Preferably, the profile matching algorithm 10 matches profiles to specific categories of user profile, under which particular content and/or programmed instructions have been stored on the content database 9. The profile categories conform to the same hierarchical structure to those of the profile categories of the client application 4, and by performing the matching of the content on the server side of the apparatus 1, no impact on the performance of the mobile device 2 occurs.

The content and/or programmed instructions in each profile category are specifically selected so as to be consistent with the personal attributes of the user. Hence, if the user 5 makes a request for a listing of restaurants in his/her home town, the profile matching algorithm 10 will match the user's profile to the appropriate profile category, having knowledge of the user's likes/dislikes, lifestyle preferences, health problems and salary for instance. Therefore, by way of example, if a business professional earning upwards of £75000 per annum, having an interest in fine wines and haute cuisine, requests restaurant listings in his home city, the server application 8 will then return a listing of any suitable ‘5 star’ or ‘Egon Ronay’ (or similar etc.) certified restaurants within a suitable distance of the city centre. Whereas, if a college student, receiving less than £5000 per annum in education grants, abiding to a strict vegetarian diet, requests a corresponding listing of restaurants, the server application 8 will return only vegetarian and/or vegan restaurants and/or cafes which are within the budget of the student.

If a particular content is not available locally to the data resource 3, it will automatically search the resources of the internet to find the relevant information. However, the searching will be consistent with the user's profile, and therefore in the preceding ‘restaurant listing’ examples, only 5 star restaurant details will be located and retrieved form the internet for the business professional etc. Where information is retrieved from the internet, the server application 8 preferably includes one or more parsing algorithms that can extract data (e.g. text and pictures) from web pages etc. and convert it into a form appropriate to the user's profile.

The profile matching algorithm 10 will only match content that is appropriate having regard to the user's profile. Therefore, the algorithm can provide a certain degree of inherent ‘parental control’ for user's who are below the age of 18 years for instance. Therefore, should a user request content of a more ‘adult’ nature, but their user profile has been matched to a category of male in the age range 11-15 years old, the server application 8 will refuse to return any requested content, and may instead offer a more appropriate content by way of an alternative. Hence, for example, if a teenage user requests cinema show times for adult-rated movies, the profile matching algorithm 10 will then determine that the requested content is not suitable for that user, and will refuse to return that information, or preferably, return show times for movies having. a certification of 15 years or less.

Preferably, in respect of each profile category on the data resource 3, there is stored additional related data and information which is deemed to be specific to the personal attributes of that user. Hence, if the VPIM has determined that the user suffers from a skin complaint, e.g. acne, the corresponding profile category in the content database 9 may contain details of skin care products, skin treatment advice and listings of medical practitioners specialising in skin disorders etc. Therefore, in addition to returning the requested content to the user, skin product details, advice and listings may be also returned by way of pop-up messages, images and/or advertisement banners etc. as appropriate.

As a further example, if it has been determined that a particular user has a profile which indicates that the individual suffers from stress, or exhibits periods of unhealthy anxiety, the corresponding profile category in the content database 9 may contain listings of stress management and counselling services, herbal stress remedies and/or listings of telephone advice helplines etc., which again may be returned to the user along with any requested content.

When an appropriate content has been matched to the user's request, having regard to the user's profile, the server application 8 prepares the content (and any additional useful information that it deems suitable) for transmission back to the mobile device 2. The content may either be transmitted in HTML, XML or any other suitable file type, or as an applet or programmed instructions, or any combination of these different formats as appropriate.

The mobile device 2 receives (i.e. downloads) the content and/or program instructions from the data resource 3 over the communications network and proceeds to convey the corresponding information to the user in a format appropriate to the user's profile. In accordance with the functionality of the mobile device 2, the returned information may be conveyed to the user either visually and/or audibly in one or more of the following formats: textual, graphical, pictorial, video, animation and audio.

It is to be appreciated that any suitable technique of conveying the information to the user may be used, and in particular any combination of the preceding formats may be used in conjunction with one or more of the others.

Preferably, the client application 4 is configured to format the received content in the most appropriate manner having regard to the user's profile. Therefore, should the user be a business professional requesting financial markets information, the content will be presented to the user in a professional style, using a text-based layout and colouration suitable to that person. If the user is a child and the requested content is for a video clip of the child's favourite cartoon television programme, the client application 4 will adapt the layout and colouration so as to be quite bold, chunky and simple in form.

If the user profile indicates that the user suffers from an eye disorder, e.g. poor eyesight, and/or possibly has a hearing problem or any other form of sensory disability, the client application 4 can adapt the manner in which the received content is to be conveyed to the user, as appropriate to that condition. Hence, for example, if the user has poor eyesight the content can be conveyed using an increased font size in a text-based layout and/or may be conveyed using audio means e.g. via the mobile device's speakers etc.

It is to be appreciated that the user may also manually configure or set the display and/or any audio playback features in the client application 4, so as to provide a range of preferences for the manner in which content is to be conveyed and presented to the user. These preferences can be inspected by the MUPIM during execution of that module, which can be used to determine further personal attributes of the user, e.g. a preference for a large display font could be indicative of poor eyesight etc.

If upon receiving and inspecting the requested content, the user 5 of the mobile device 2 desires additional content and/or further information, whether related to the first content or not, they may then issue further requests to the mobile device 2. In so doing, the client application 4 will then be responsive to the further interactions between the device 2 and user 5, and can use the additional data from the interactions to update the user's profile, thereby adaptively profiling the user in real-time.

However, should the user 5 be satisfied with the received content, or else has no further use for the mobile device 2 at that time (and hence expressly closes the client application), the client application 4 will store the current user's profile in non-volatile storage (e.g. in non-volatile memory or on any associated hard disk drive etc.) when it is closed down, for subsequent use during a later interaction. In this way, the mobile device 2 preserves the user profile and already has an existing knowledge of the user when the client application 4 is next launched.

Referring to FIG. 2, there is shown an exemplary flowchart of a preferred use of operation of the present apparatus 1. Hence, a user 5 when desiring to obtain a particular content or information will launch (step 20) the client application 4 on the mobile device 2. The user 5 will interact (step 22) with the device 2 by issuing their request either via an input text or by providing a verbal command or instruction etc., while also typically holding or gripping the device etc. At this time, any of the sensor or sensor types, as discussed earlier, are operable to collect information concerning personal attributes of the user, while additionally the mode of use of the device may also be monitored.

One or more of the software modules 6₁ . . . 6_{N} (MUPIM, PPIM, TPIM, CPIM, APIM and VPIM) will then commence processing and interpretation of the interactions (step 24) between the mobile device 2 and the user 5, in order to detect and determine the personal attributes of the user (step 26). Each of the software modules 6₁ . . . 6_{N} involved in interpreting a particular interaction will produce a text file containing one or more keyword tags related to a personal attribute of the user. Each of these text files are then provided to the optimisation algorithm 7, which resolves any disputes between determined attributes and then either defines a new, or updates any existing, profile (step 28).

The new or updated user profile is transmitted to the remote data resource 3 via a communications network, together with the user's request for content or information. (step 30). The server application 8 executing on the data resource 3 identifies the nature of the user's request and invokes a profile matching algorithm 10, which matches the user's profile to a hierarchical structure of profile categories, each of which is separately defined by a predetermined set of one or more personal attribute criteria. The profile matching algorithm 10 matches the user's profile to a particular category of content and/or programmed instructions (step 32), which are specifically selected and suited to the user's profile. The server application 8 prepares the requested content and any other information that it deems to be relevant to the user (having regard to the user's profile), and transmits it to the mobile device 2. The mobile device 2 downloads (step 34) the content from the data resource 3 and then proceeds to convey the content to the user in the most appropriate format suited to the user's profile (step 36). This may take into consideration any preferences the user has previously made, any known or suspected sensory conditions (e.g. poor eyesight) that the user may have and/or any ‘parental control’ measures as may be necessary depending on the nature of the requested content.

If additional content is required by the user (step 38), the user 5 may then issue further requests to the device 2, all the while interacting with the device in one or more different ways (step 22). Thereafter, the subsequent steps of the flowchart (steps 24 to 38) will apply as before, until the user no longer requires any further content or information.

When the user 5 is satisfied with the received content and desires no additional information, the client application 4, when expressly closed down, will store the user's profile (step 40) for subsequent use during a later interaction, thereby ending the session with the remote data resource 3 and existing (step 42) the application.

Although the adaptive profiling apparatus of the present invention is ideal for identifying relevant content for a user of a mobile device based on a determination of the user's profile, it will be recognised that one or more of the principles of the invention could be used in other interactive device applications, including ATM machines, informational kiosks and shopping assistants etc.

Other embodiments are taken to be within the scope of the accompanying claims.

1. A method of operating a mobile computing device for interacting with and adaptively profiling a user in order to retrieve content and information requested by and tailored to the user from a remote data resource, comprising the steps of:
i) detecting personal attributes of the user by interpreting one or more interactions between the device and the user;
ii) defining on the device a profile of the user based on the detected personal attributes;
iii) transmitting the user profile and a user defined request for content and information to the remote data resource;
iv) determining, at the remote data resource and as a function of the transmitted user profile, content and information to be downloaded to the mobile computing device; and
v) downloading the content and information to the device and configuring the device to convey the corresponding content and information in an optimum manner by automatically selecting on the device the most appropriate output format for that content and information having regard to the user profile;
wherein the conveying includes optimising the visual layout and/or audio properties of the output format.

2. The method of claim 1, wherein interpreting an interaction involves determining a mode of use of the device.

3. The method of claim 1, wherein interpreting an interaction involves parsing a natural language request and/or parsing an input textual command string.

4. The method of claim 1, wherein interpreting an interaction involves processing a signal received from one or more of the following sensors associated with the device: pressure, temperature, chemical, audio and visual.

5. The method of claim 1, wherein interpreting an interaction involves processing an image of the user obtained by the device.

6. The method of claim 5, wherein the processing of the image includes recognising facial features and identifying facial expressions of the user.

7. The method of claim 1, wherein the step of defining on the device a profile further comprises updating an existing profile for the user based on the personal attributes.

8. The method of claim 1, wherein defining the user profile includes applying an optimisation algorithm to the personal attributes to determine the profile category to which the user belongs.

9. The method of claim 8, wherein the optimisation algorithm is associated with a plurality of hierarchical profile categories, each separately defined by a predetermined set of one or more personal attribute criteria.

10. (canceled)

11. The method of claim 7, wherein determining at the remote data resource involves matching the user profile of the user to at least one of data the response to the request for information that is specific to the profile category of the user.

12. (canceled)

13. The method of claim 1, wherein the corresponding information is conveyed either visually and/or audibly in one or more of the following formats: textual, graphical, pictorial, video, animation and audio.

14. The method of claim 7 , further comprising storing the user profile on the device in a non-volatile storage means.

15. An apparatus comprising:
i) a mobile computing device for interacting with and adaptively profiling a user and for requesting and retrieving content and information from a remote data resource, including:
ii) means for detecting personal attributes of the user by interpreting one or more interactions between the device and the user;
iii) means for defining on the device a profile of the user based on the detected personal attributes;
v) means for transmitting the user profile and a request for content and information to the remote data resource; and
wherein the remote data resource includes a means for determining as a function of the transmitted user profile, information and content to be downloaded to the mobile computing device; and means for transmitting the the requested information and content to the mobile computing device, wherein the device is configured to convey the transmitted content and information in a in an optimum manner by automatically selecting on the device the most appropriate output format appropriate for that content and information having regard to the user profile;
wherein the convening includes optimising the visual layout and/or audio properties of the output format.

16. The apparatus of claim 15, wherein the mobile computing device is one of the following devices: a laptop, a PDA, a mobile phone and a tablet PC.

17. The apparatus of claim 15, wherein the remote data resource is a server having one or more associated databases for storage of data content and program instructions.

18. A mobile computing device for interacting with and adaptively profiling a user and for communicating with a remote data resource to retrieve content and information requested by and tailored to the user from the remote data resource, comprising:
i) means for detecting personal attributes of the user by interpreting one or more physical interactions between the device and the user;
ii) means for defining on the device a profile of the user based on the detected personal attributes;
iii) transmitting means for transmitting to the remote data resource the user profile and a request for content and information from to the remote data resource; and
iv) receiving means for receiving from the remote data resource content and information tailored to the user profile; and
(v) means for configuring the device to convey the content and information from the remote data resource in an optimum manner by automatically selecting on the device the most appropriate output format for that information having regards to the user profile; wherein the conveying includes optimising the visual layout and/or audio properties of the output format.

19. The device of claim 18, wherein the device is in the form of one of the following devices: a laptop, a PDA, a mobile phone and a tablet PC.

20. The device of claim 18 , wherein the means for detecting includes one or more of the following sensors: pressure, temperature, chemical, audio and visual.

21. A remote data resource for communicating with a mobile computing device, comprising:
i) receiving means for receiving a user defined request for content and information and a user profile from the mobile computing device, said the user profile being based on the personal attributes of the user of the device;
ii) means for determining as a function of the user profile, requested content and information tailored to the user profile for transmitting to the device; and
iii) transmitting means for transmitting the content and information to the device; and
wherein the remote data resource comprises at least one database having stored thereon a plurality of data content and/or programmed instructions arranged in accordance with a plurality of hierarchical user profile categories.

22. (canceled)

23. The method according to claim 1 wherein the profile of the user based on the detected personal attributes comprises attributes selected from the group consisting of gender, age, ethnic group, hair colour, eye colour, facial marks, complexion, health, medical conditions, personality type, likes, dislikes, interests, hobbies, activities and lifestyle preferences.

24. The method according to claim 1 wherein the data content or program instructions to be downloaded to the mobile computing device is information or content requested by the user and is accessed by connection to the internet.
